(19) United States
(12) Patent Application Publication
(10) Pub. No.: US 2013/0124547 A1
(43) Pub. Date: May 16, 2013

(54) System and Methods Thereof for Instantaneous Updating of a Wallpaper Responsive of a Query Input and Responses Thereto

(71) Applicants: Rami KASTERSTEIN, Givataim (IL); Amihay BEN-DAVID, London (GB); Joey Joseph SIMHON, Ramat-Gan (IL)

(72) Inventors: Rami KASTERSTEIN, Givataim (IL); Amihay BEN-DAVID, London (GB); Joey Joseph SIMHON, Ramat-Gan (IL)

(73) Assignee: Doat Media Ltd., Givataim (IL)

(21) Appl. No.: 13/296,619

(22) Filed: Nov. 15, 2011

(51) Int. Cl. G06F 17/30; G06F 3/048

(52) U.S. Cl. 707/758; 715/810; 707/E17.014

(57) ABSTRACT

A method for instantly updating a wallpaper on a screen of a user device responsive of a user query. The method comprises performing an analysis of the user query input by a user of the user device; selecting a wallpaper respective of at least the user query that is determined to be related to the user input; and providing the selected wallpaper to the user device for a display on the screen of the user's device.

### TECHNICAL FIELD

The disclosed invention generally relates to search engines, and more specifically to techniques of presenting images in the form of a wallpaper on a display respective of potential search results and/or respective of a query.

### BACKGROUND OF THE INVENTION

Web search engines are increasingly becoming the method used for the purpose of seeking information on the worldwide web (WWW). As the WWW continues to exponentially grow in size and content, the task of finding relevant and pertinent information to a user's search query becomes increasingly complex. Not only do users expect answers to their search queries to be returned instantaneously, they also expect that the top answers returned relate specifically to what they are searching for. Notably, web search engines, typically implemented on search servers, are computer programs accessible by web browsers or other applications designed to search the WWW and retrieve web content that includes files and documents accessible on the WWW and hosted by websites. The most prominent search engines are those of Google® and Bing™.

Other types of known web search engines include vertical comparison engines as well as widget and gadget based personal homepage dashboards. Vertical comparison engines typically compare items retrieved from various other websites. For example, PriceGrabber.com®, Shopping.com® and Shopzilla®.com enable a user to compare the price of a given product at multiple stores. Widget and gadget based personal homepage dashboards enable a user to design a personalized homepage or personal web portal which may include a plurality of applications known as widgets or gadgets that can provide a user with information. Netvibes®.com, iGoogle® and My Yahoo!® are all examples of widget and gadget based personal homepage dashboards.

In either search method, search engines do not customize presentation in response to the input query. Typically, text and or thumbnails of potential web pages are presented when the query is submitted to the search engines' databases and/or index servers. A user enters a query in a free text format, and this query is processed as such. The user has the option to narrow the search to a certain category, for example, by selecting one of the predefined categories provided by the search engines, or by selecting one or more autocompleted potential search phrases. For example, the user may select an “images” search engine and enter a free text query, if the user seeks to find a certain image. However, the categories are predefined and limited and are not associated with the search term.

As a user's positive experience with the search engine ensures longer and more frequent use of specific search engines, attempts are constantly made to improve the user experience. Most search engines, such as Google or Bing tend to have a look and feel which generally remains constant responsive of search queries. However, in the continuous pursuit for exciting user experiences it would be advantageous to provide a user interface solution that would further enhance a user's experience respective of a search query or a portion of a search query.

### SUMMARY OF THE INVENTION

Certain embodiments disclosed herein include a method for instantly updating a wallpaper on a screen of a user device responsive of a user query. The method comprises performing an analysis of the user query input by a user of the user device; selecting a wallpaper respective of at least the user query that is determined to be related to the user input; and providing the selected wallpaper to the user device for a display on the screen of the user's device.

Certain embodiments disclosed herein also include an apparatus for instantly updating a wallpaper of a user device responsive of a user query. The apparatus comprises an interface to a network to communicate with at least the user device; at least a processor connected to the interface; and a memory containing instructions that are executed by the at least processor when the user query is received from the user device for identification of at least a wallpaper corresponding to the user query and to provide the at least wallpaper to the user device through the interface over the network, wherein the at least wallpaper replaces a wallpaper currently displayed on a screen of the user device.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system for instantaneous updating a wallpaper of a device in accordance with an embodiment.

FIG. 2 is a flowchart describing the operation of the system for instantaneous updating of a wallpaper of a device respective of a query and its search results in according with an in accordance with an embodiment.

FIG. 3 is a schematic diagram of a first display screen rendered in accordance with an embodiment.

FIG. 4 is a schematic diagram of a second display screen rendered in accordance with an embodiment.

FIG. 5 is an exemplary screenshot of a mobile device's display area including a wallpaper provided in response of a query input.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments presented herein allow for instant updates of background content, such as a wallpaper of a display respective of a query entered by a user. A user who wishes to find information may make use of a search engine that receives an input of a query. Responsive to the query, or portions thereof, the background content is selected from an appropriate resource that is responsive of that query. The wallpaper may include any one of, or combination thereof, of an image, a video clip, a banner, a toolbar, or a series of images replaced in a predefined speed over the user's device display. In one embodiment, the background content is displayed as the background of a web browser or any other application designed to retrieve information respective of a query.

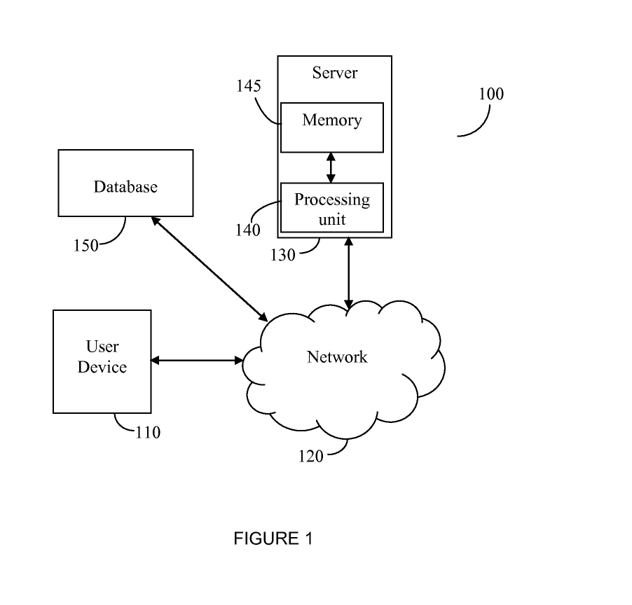

FIG. 1 shows an exemplary and non-limiting schematic diagram of a system 100 in accordance with an embodiment of the invention. A user inputs a query, or a portion thereof, by a user device 110 such as but not limited to, a personal computer (PC), a notebook computer, a tablet computer, a smart phone, or a mobile device, which communicates with a server 130 through a network 120. The network 120 may be wired, wireless, cellular, a local area network (LAN), a wide area network (WAN), a metro area network (MAN), the Internet, the worldwide web (WWW), the like, and any combination thereof.

The server 130 receives the query, or the portion thereof, and processes it using a processing unit 140, operative by execution of instructions stored in memory 135. A query may be comprised of a keyword, a portion of a keyword, several keywords, free text, characters or letters. Suggestions for a complete query to a portion of a query may be provided based on user preferences or other types of indications, such as, but not limited to, popularity, trends, etc., for example, from a database 150.

Simultaneously, and based on the query or portions thereof, the server 130 selects from preferably a plurality of choices of images, an image for use as a wallpaper or a background content to the web browser or search engine application. The images may be stored in the database 150 coupled to the network 120, and may include still images, a collection of still images to be presented one after another, or a video clip, where the images are such that they are suitable to be used as a wallpaper for the user device 110. The database 150 may also include an image search engine capable of providing images. In one embodiment, the database 150 maybe connected directly to the server 130, and may be any kind of tangible data repository of content for wallpapers. For example, the database 150 may be of one or more image banks, a cache, and so on. In another embodiment, the content for wallpapers and/or the background content may be stored in the server 130, for example, in the memory 145.

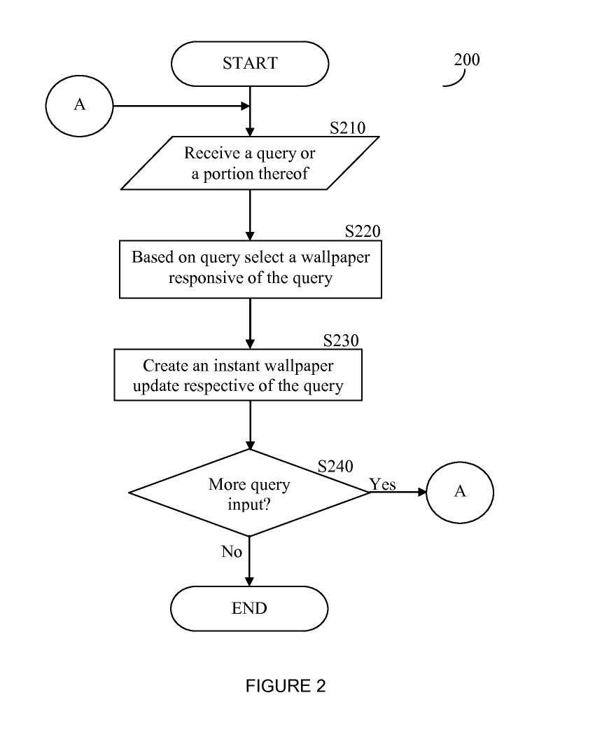

FIG. 2 depicts an exemplary and non-limiting flowchart 200 describing the embodiment of instant update of a wallpaper of a device responsive of search results to a query, or portions thereof. For the sake of brevity and without departing from the scope of the invention it should be understood that a wallpaper of a user device also includes any form of background content displayed in the background of a web browser application or any other application, such as an internet mobile application, used to retrieve information from the network.

When a portion of a query is input, the server 130 continuously monitors the user's inputs and immediately responds with updates to the wallpaper as described in the various steps herein below. That is to say that the server 130 need not wait until the entire query is typed in by the user, but may act to update the wallpaper the moment sufficient data from the query is available or as soon as a potential user's intent based on the user preferences or indications is identified.

In S210, the server 130 receives as an input a query, or a portion thereof, from a user, for example, a user of the user device 110. In S220, based on the received input, the server selects a wallpaper that is related to the input query responsive thereof. For example, if the query begins with the phrase “New York” an image of the city's skyline may appear. It may then change when the word “attractions at night” is added and the selected image may change to an image of Times Square at night. It should be noted that the selection of an image from a plurality of images may be performed in a variety of ways all of which are to be considered as an integral part of the invention. In one embodiment, an image may be selected randomly from a plurality of images responsive of, but not limited thereto, a user beginning to enter a query and before any kind of specific determination can be made. In another embodiment, the content selection is based on correlation above a predefined threshold between metadata associated with content (e.g., an image) and the input query or portion thereof.

In S230, the server 130 creates an instant wallpaper from the selected content. In S240, it is checked whether additional inputs are to be handled by the server 130, and if so execution continues with S210; otherwise, execution terminates. As noted above, the content displayed in response to the input query (or portion thereof) may include, but is not limited to, an image, images, still pictures and series of pictures, graphics, video clips, and the like.

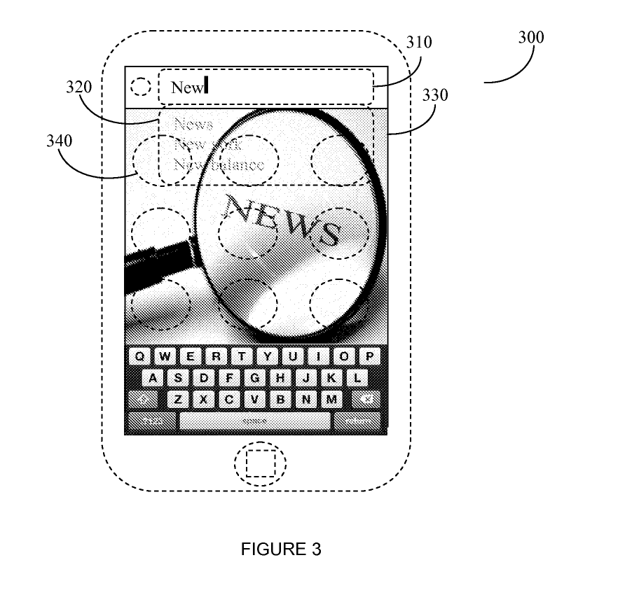

FIG. 3 shows a schematic diagram of a front view of an exemplary display screen of a typical mobile device 300 rendered in accordance with an embodiment. The user of a user device 110 can enter a portion of a query in a search bar 310, for example, the word “new”. Responsive thereto, the server 130 simultaneously suggests one or more complete queries 320 with respect of the portion of the query, for example, the query term “news” and creates an instant wallpaper 330 with respect of the suggested query. Over the wallpaper 330 there are displayed a plurality of icons, e.g., an icon 340. Each icon may represent an Internet mobile application (APP).

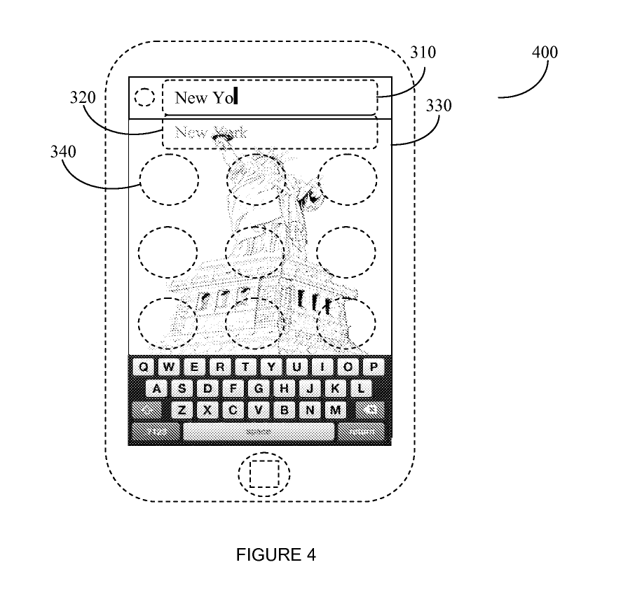

FIG. 4 shows a schematic diagram of a front view of an exemplary display screen of a typical mobile device 400 in accordance with an embodiment. Using the example of FIG. 3, the user continues the query input by entering the term “new york.” Instantly, the server 130 updates the wallpaper 330 with respect of the updated query input “new york.” This time the display shows, for example, an image of the Statue of Liberty.

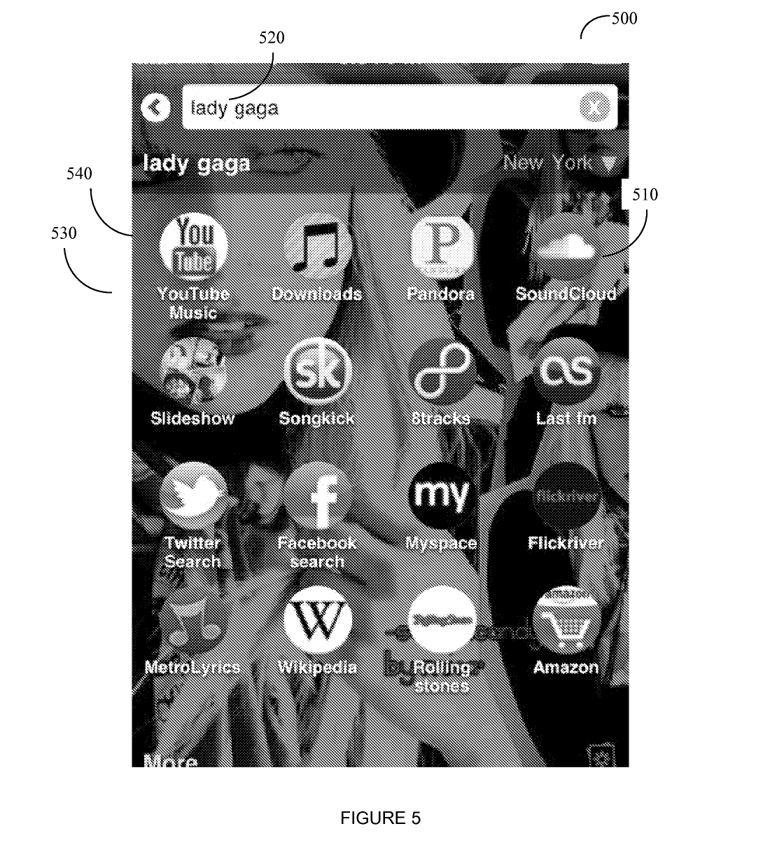

FIG. 5 shows an exemplary and non-limiting screenshot 510 of a screen of a typical mobile device 500. The user can enter a query that may contain search terms as explained hereinabove, in a search bar 520. If a user enters, for example, the term “Lady Gaga” an instant wallpaper with one or more pictures of Lady Gaga as a wallpaper 530 is displayed on a display of the mobile device 500.

A person of ordinary skill in the art would readily appreciate the fact that a wallpaper may be a result of a single or a plurality of images. A wallpaper may further be a combination of an image and a video clip, a video clip on its own, and/or a series of images displayed consecutively or randomly. Replacement of wallpaper images may occur periodically at a constant or changing speed. Furthermore, an appropriate banner and/or toolbar may be further added as part of the wallpaper, all without departing from the scope of the invention.

The various embodiments of the invention may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for instantly updating a wallpaper on a screen of a user device responsive of a user query, comprising:
performing an analysis of the user query input by a user of the user device;
selecting a wallpaper respective of at least the user query that is determined to be related to the user input; and
providing the selected wallpaper to the user device for a display on the screen of the user's device.

2. The method of claim 1, wherein the user query is at least one of: a keyword, a portion of a keyword, a plurality of keywords, a character, and a series of characters.

3. The method of claim 1, wherein the wallpaper is at least one of: an image, a series of images, a video clip, a series of video clips, a banner, and a toolbar.

4. The method of claim 3, wherein the wallpaper content is periodically replaced.

5. The method of claim 1, wherein selecting the wallpaper respective of at least the user query comprises:
selecting a wallpaper from a data repository where a correlation above a predetermined threshold exists between the user query and metadata of the wallpaper.

6. The method of claim 1, wherein selecting the wallpaper respective of at least the user query comprises a random selection from a data repository when a portion of the user query is input.

7. The method of claim 1, further comprises:
finding a match between at least a portion of the user query and a previously presented query.

8. The method of claim 7, further comprises:
auto completing the user query.

9. The method of claim 1, wherein selecting the wallpaper further comprises:
selecting the wallpaper respective of at least a response received with respect of the user input.

10. The method of claim 1, wherein the method further updates, responsive of the user query, a background content displayed in a segment of a display area of a graphical user interface of any one of a web browser and an Internet mobile application.

11. A non-transitory computer readable medium having stored thereon instructions for causing one or more processing units to execute the method according to claim 1.

12. An apparatus for instantly updating a wallpaper of a user device responsive of a user query, comprising:
an interface to a network to communicate with at least the user device;
at least a processor connected to the interface; and
a memory containing instructions that are executed by the at least processor when the user query is received from the user device for identification of at least a wallpaper corresponding to the user query and to provide the at least wallpaper to the user device through the interface over the network, wherein the at least wallpaper replaces a wallpaper currently displayed on a screen of the user device.

13. The apparatus of claim 12, wherein the user query is at least one of: a keyword, a portion of a keyword, a plurality of keywords, a character, and a series of characters.

14. The apparatus of claim 12, wherein the wallpaper is at least one of: an image, a series of images, a video clip, a series of video clips, a banner, and a toolbar.

15. The apparatus of claim 12, wherein the wallpaper content is periodically replaced.

16. The apparatus of claim 12, wherein the at least wallpaper is selected respective of at least the user query based on a correlation between the user query and metadata of the wallpaper, wherein the selection is from a plurality of wallpapers saved in a data repository.

17. The apparatus of claim 12, wherein the at least wallpaper is randomly selected from a data repository when a portion of the user query is received.

18. The apparatus of claim 12, wherein the memory containing instructions further contains instructions that when executed by the at least processor find a match between at least a portion of the query input and a query stored in a database and auto-complete the user query.

19. The apparatus of claim 12, wherein the memory containing instructions further contains instructions that when executed by the at least processor select the wallpaper respective of at least a response received with respect of the query input.

20. The apparatus of claim 12, wherein the user device is at least one of: a personal computer (PC), a notebook computer, a tablet computer, a smart phone, and a mobile device.

21. The apparatus of claim 12, wherein the apparatus is further configured to instantly update, responsive of the user query, a background content displayed in a segment of a display area of a graphical user interface of any one of a web browser and an Internet mobile application.
